(19) United States
(12) Patent Application Publication
(10) Pub. No.: US 2006/0192869 A1
(43) Pub. Date: Aug. 31, 2006

(54) Multi-dimensional input, transfer, optional memory, and output method

(76) Inventors: Kazutora Yoshino, Eden Prairie, MN (US); Emily Yoshino, Eden Prairie, MN (US)

Correspondence Address: Kazutora Yoshino, 7227 Divinity Ln, Eden Prairie, MN, 55346, US

(21) Appl. No.: 11/066,940

(22) Filed: Feb. 28, 2005

(51) Int. Cl. H04N 3/14; H04N 5/335

(52) U.S. Cl. 348/294

(57) ABSTRACT

Color 3D image input device (digitizer) and 3D image output device (display) that captures and show 3D images having the light fields. Direction-position-color of the light fields are controlled by various methods such as liquid crystal masks with photo-sensors, liquid crystal masks with color-image-emitter. Alternatively, micro-lens-array, micro-pinholes, liquid crystal pinholes, varifocal micro-lens arrays and varifocal index-gradient lens, etc. are used together with high-resolution and high-speed pattern-generating means with photo-sensors and photo-emitters. This can be used for 3D communication, 3DTV, 3D camera, cloaking device.

### FEDERALLY SPONSORED RESEARCH

Not Applicable

### SEQUENCE LISTING OR PROGRAM

Not Applicable

### BACKGROUND OF INVENTION

1. Field of Invention

This invention relates to the image capture, memory, and display devices such as 3D camera, 3D digitizer, 3D scanner, memory, video-random access memory, digital video device, hologram, stereo display device, volumetric display device that are used for displaying the 3 dimensional object or images.

2. Description of Prior Art

In the conventional way, it was difficult to capture and display the 3 dimensional object or images in real time (run time) by viewed by the multiple users without special glasses in the space only by light or special 3D scanner.

There are some 3 dimensional digitizer and displays available.

The early excellent digitizer was made by L.D.I. to capture 3D image. They use the triangular laser wave to get the line on object and analyze the 3D shape. But this takes some time and not fitting too much on motion 3D capturing.

The virtual headsets are showing the two different images to each eye of users by screens to create the 3 dimensional images. The shutter glasses can also show 3D images having fast changing alternating left and right images. But many people feel uncomfortable wearing such devices and some gets cyber sick easily.

The holograms are showing 3 dimensional images, but these images are difficult to be changed in real time (run time).

The conventional method to project the 2 dimensional image to rotating plate, spiral screen, reciprocating screen to create 3 dimensional image shows only the surface shape of images and they don't show realistic 3 dimensional image. (Actuality, Felix, Act Research) The conventional method to project the 2 dimensional images to plurality of semi-transparent plates to create 3 dimensional images are very expensive because multiple DMD, GLV costs a lot. U.S. Pat. No. 5,394,202 (Deering, 1995) and U.S. Pat. No. 907,312, (Sato, et al., 1999) release some of these methods.

In Japanese Patent No. 288957 or H01-193836 (Felix Gashia, et al, 1989) shows the way to make 3 dimensional image by project the 2 dimensional image to rotating plate. This put red, blue, green laser beam together to light fiber, and run the light to make the 2 dimensional image on the angled and rotated plate so that it would show the 3 dimensional image as a result. But, this one is rotating fast enough to be able to hurt users. And therefore, it is not suitable for user to touch the 3 dimensional image created by this device. Also, this by itself is almost impossible to show the image in the space only by light.

In U.S. Pat. No. 3,647,284 (Virgil B Ethlgs, et al., 1972) show the method of showing 3 dimensional image made by the light that was originally scattered by an object. This device put two dish means facing each other. The top dish means has ring shape, that is it has a hole in the middle, and 3 dimensional image shows up over this hole when user put the object at the bottom of the bottom dish means. Each of dishes has reflecting material inside to reflect lights. But this device by itself would be unsuitable to show the real time (run time) 3 dimensional image because it is composed of two dishes.

SHARP, INC. and 3DT, INC. has developed the 2-eye method 3 dimensional displays for a flat panel. Users can see from one angle and cannot locate themselves anywhere to look at the 3D image.

SANYO, INC. has developed the 3 dimensional displays using pinholes. But in their method, it is not easy to make flat panel because it need extra-bright light source behind. Also, it is difficult to apply current technology to manufactures. It tends to be expensive. Also, the data conversion from 3 D object to 2D liquid crystal takes too long time to be for run time application. And their resolution is low.

### OBJECTS AND ADVANTAGES

This invention has advantages relative to prior art in
0. This can capture and display the 3D images in realistic dimensions such as time and space.
1. This device of invention can display true realistic 3D image as if it is there.
2. Multi users can view the 3D images
3. It could show both 2D and 3D images.
4. It can be manufactured easily using current 2D display technology
5. The conversion time is small.

### SUMMARY

The device of invention can capture 3 dimensional images by having moving multiple patterns with dynamic image capturing device such as photo sensors, array of photo sensors, matrix of photo sensors, tensor of photo sensors, C.C.D., multiple layers of photo sensors and/or mask, masks, pattern generating means, etc.

For example, there are several pinhole lenses that guide the light to C.C.D. (photo sensors). The color intensity (BW included), position and directions of light are recognized by structure and C.C.D. This can be done because of the single and/or multi-layers of pinholes (patterns) masks. This pattern is used for calculation (or direct usage) to patterns of mask of 3D display. The key to capture 3D image of color, position, direction and show it as it has been captured. This reduces a lot of calculation time.

The device of invention can display 3 dimensional images by generating the virtual light distribution. And/or it can be using patterns masks. Example is described in application Ser. Nos. 10/628,541 and 10/63869 by Kazutora Yoshino.

### DRAWINGS

### Drawing Figures

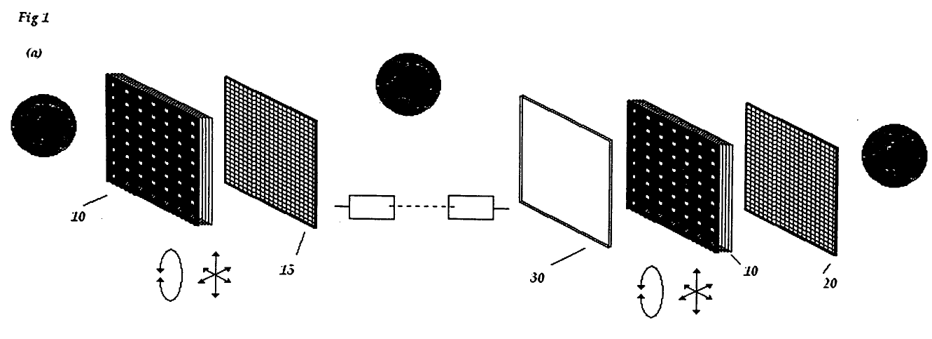

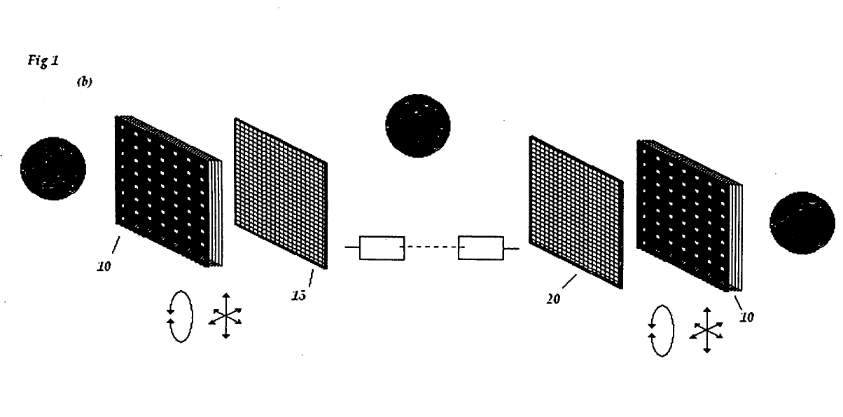

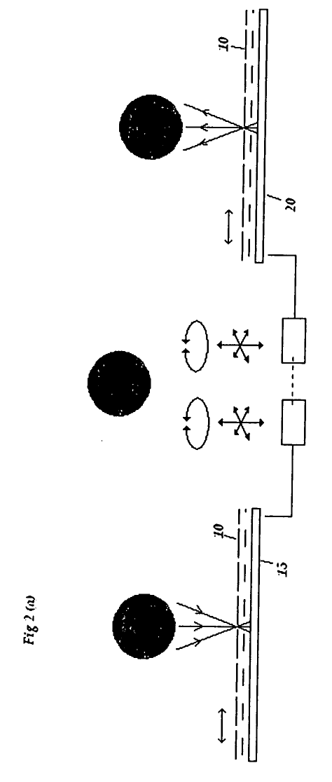

FIG. 1 through FIG. 2 shows the example diagrams of 3D input device and 3D output device from side view.

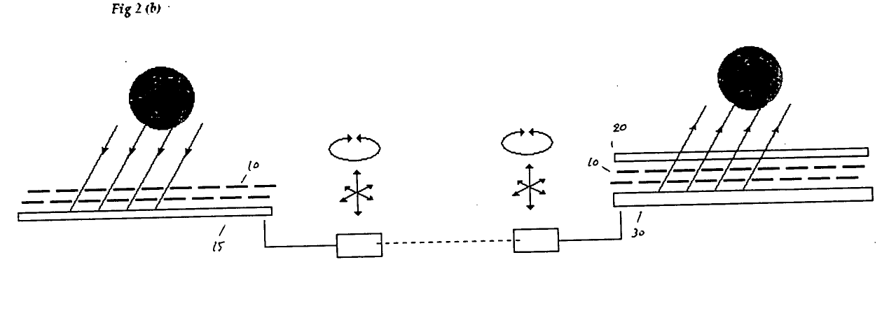

FIG. 3 through FIG. 10 shows the example diagrams of 3D scanner and 3D image display.

### REFERENCE NUMERALS IN DRAWINGS

(1) Lights Field

such as 3 dimensional light vector field, parallel beam field, conservative light vector field, non-conservative light vector field, distributed virtual light points, virtual light point(s), scanned virtual light field(s)
   (10) Pattern Making Means/Mask Means/Focal Lens Means/Display Means
such as pinhole lens arrays, micro-pinhole lens arrays, micro-lens arrays, index-gradient lens arrays, liquid crystal pinhole lens arrays, electro-optic micro-lens arrays, nematic/ferreoelectric liquid crystals arrays, liquid crystal panel with polarizing plate, 2 dimensional image pattern maker, (varifocal micro-lens arrays), fast phase-changeable panel, liquid crystal panels, liquid crystal panels with polarizing plates, ferroelectric liquid crystal panels, ferroelectric liquid crystal panels with polarizing plates, micro-lens arrays, pinhole lens arrays, moving screen, moving micro-lens arrays, moving pinhole lens arrays
vari-focal lens, electro-optic micro-lens arrays, varifocal pinhole lens, varifocal index-gradient lens, varifocal liquid crystal lens, piezo-electric lens, acousto-optic micro-lens arrays, varifocal liquid crystal Fresnel lens,
pinhole lens, pinhole lens arrays, micro-lens, micro-lens arrays, liquid crystal pinhole lens (arrays), electro-optic micro-lens (arrays), liquid crystal, nematic/ferreoelectric liquid crystals, liquid crystal panel with polarizing plate, 2 dimensional image pattern maker, varifocal micro-lens (arrays), index-gradient lens (arrays),
mask(s), 2 dimensional image pattern maker, liquid crystal, nematic/ferreoelectric liquid crystals, liquid crystals with polarizing plate
   (15) Photo Sensors Means and/or Light Receiving Means
photo sensors, CCD, arrays or photo sensors, matrix of photo sensors, tensors of\-\-photo sensors, sensors, multi-layers of photo sensors.
   (20) Image Display Means
such as liquid crystal display, ferroelectric liquid crystal, nematic liquid crystal, liquid crystal panel with polarizing plates, micro-liquid crystals arrays, micro-liquid crystals arrays with polarizing plates, ferroelectric micro-liquid crystals arrays with polarizing plates, plasma display, organic electro-luminescent display, laser arrays, micro-laser arrays, diode laser arrays, nano-2D pattern generator (light diffraction generator), CRT
   (30) Light Source Means
such as light source, uniform diode light emitter, arc lamp with optics, light fibers with light source, lasers, lasers with optics, parallel beam generator, light conservative vector field generator, light source with polarizing plate(s), polarized light source

### DETAILED DESCRIPTION

Description—FIG. 1, FIG. 2, Preferred Embodiment

A preferred embodiment of the 3 dimensional Image Scanner and Display inventions is illustrated in FIG. 1.

FIG. 1 (a) shows the example diagrams of 3D Image scanner and display from side view. This can be made of fast response liquid crystal panels with polarizing plate that capture the angles, position and colors. The fast liquid crystal creates the patterns of slots arrays. The rays that enter the slots would be captured in photo sensors such as C.C.D. This reads the directions of rays positions and colors. By changing the slots position fast, it reads the entire rays distribution. Optionally, analyzing this light distribution, and transferring the pattern to 3D display, it can show the 3D images. This could be done in single form such as 3D camera or complicated or distant form such as internet connection for 3D communication. For example, it can capture the 3D images of user at one location on the earth with showing the 3D images of the other user. Similarly, this could be done in sound field.

FIG. 2 (a) shows the example diagram from side. The lights enter slots through which lights get to sensor.

Description—The rest Alternative Embodiment

FIG. 1 (b) shows the example diagrams of 3D Image scanner and display from side view. This can be made of fast response liquid crystal panels with polarizing plate that capture the angles, position and colors. The fast liquid crystal creates the patterns of slots arrays. The rays that enter the slots would be captured in photo sensors such as C.C.D. This reads the directions of rays positions and colors. By changing the slots position fast, it reads the entire rays distribution. Optionally, analyzing this light distribution, and transferring the pattern to 3D display, it can show the 3D images. This could be done in single form such as 3D camera or complicated or distant form such as internet connection for 3D communication. For example, it can capture the 3D images of user at one location on the earth with showing the 3D images of the other user. Similarly, this could be done in sound field.

FIG. 2 (b) shows the example diagram from side. The lights enter slots through which lights get to sensor.

FIG. 3 shows the example diagrams of alternative 3D Image scanner and display from perspective view. Masks have relatively longer slots. This increases the technical speed. The long slots could move such as horizontally, vertically, rotationally, randomly, or amolfasly. This can be made of fast response liquid crystal panels with polarizing plate that capture the angles, position and colors. The fast liquid crystal creates the patterns of slots arrays. The rays that enter the slots would be captured in photo sensors such as C.C.D. This reads the directions of rays positions and colors. By changing the slots position fast, it reads the entire rays distribution. Optionally, analyzing this light distribution, and transferring the pattern to 3D display, it can show the 3D images. This could be done in single form such as 3D camera or complicated or distant form such as internet connection for 3D communication. For example, it can capture the 3D images of user at one location on the earth with showing the 3D images of the other user.

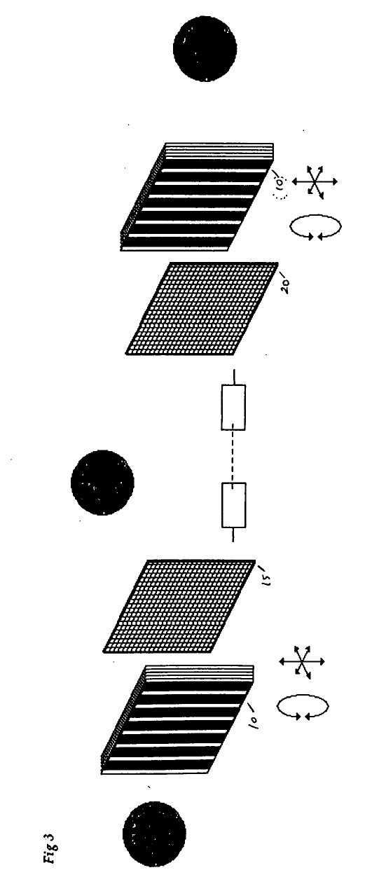

FIG. 4 shows the example diagram of 3D input device with micro-lens-arrays.

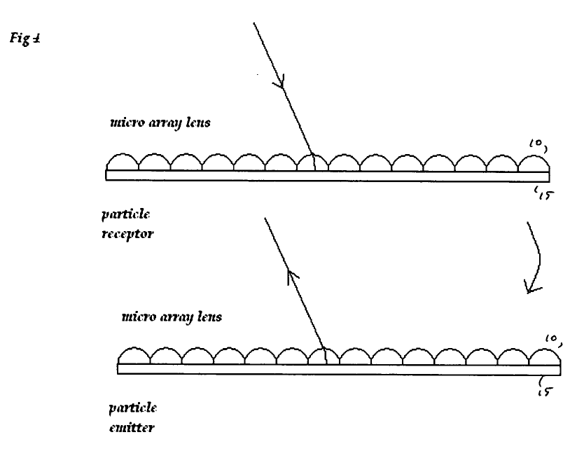

FIG. 5 (1)(2)(3)(4) shows the example diagram of application of 3D input device and 3D output device. It could have the form of 3D camera, 3D video, 3D cell-phone, 3D communicator.

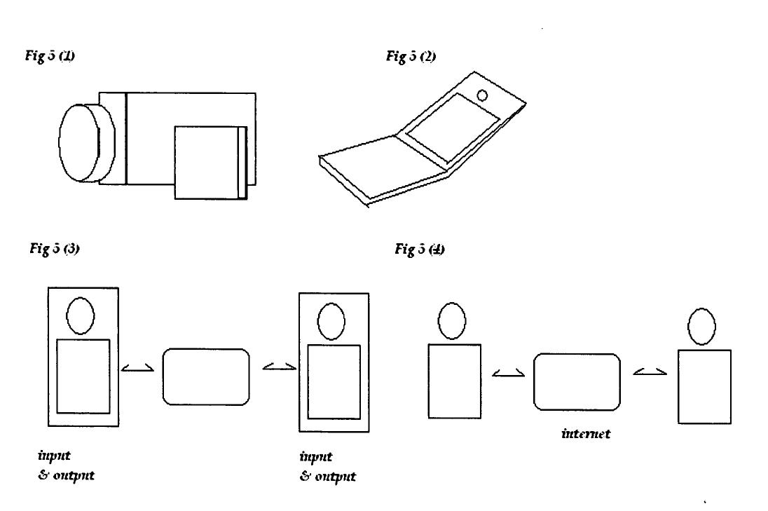

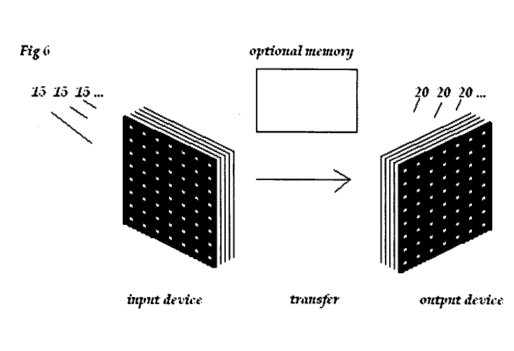

FIG. 6 shows the example diagram of multi-layer field sensors. This sensor senses the field around itself.

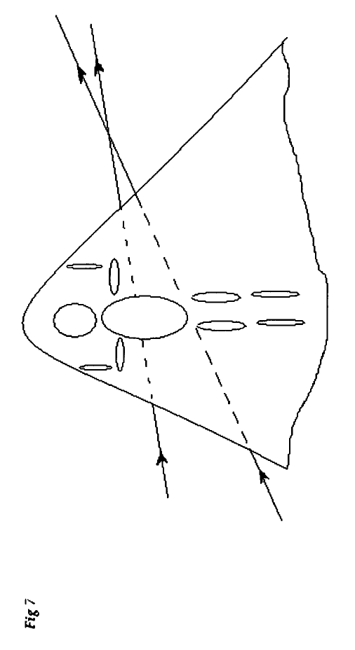

FIG. 7 shows the example diagram of applications. If we make this by flexible materials such as fibers, plastic, etc., it could be used as cloaking device. One side receives the back image in 3D and it can show the 3D images in reverse side, as if there is no object existing in the cloaking device. In case that fighters use this, it could have highly durable materials such as bullet proof material/fibers. And in order to avoid infrared detector/sensor, it could have heat control sheet as well. There could be more stuffs added properly. The unit of receiving and emitting photons could be the same unit or separated units, such as put close to each other.

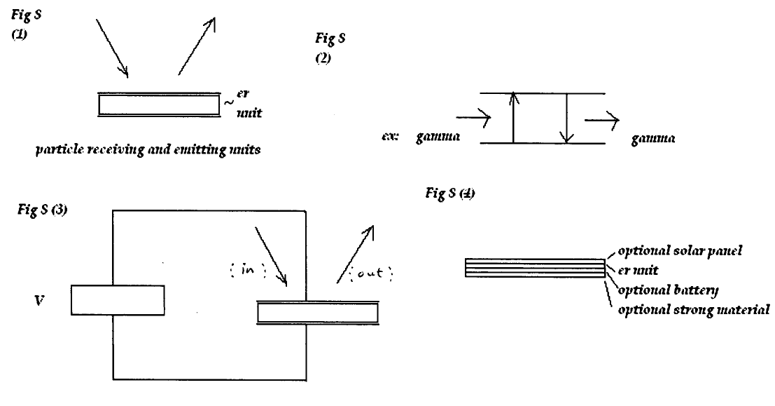

FIG. 8 (1),(2),(3),(4) shows the example diagram of units. It could be used for cloaking device for example. It can use or charge the electricity when particles like photons get into the unit. It can use the energy for emitting particle like photons.

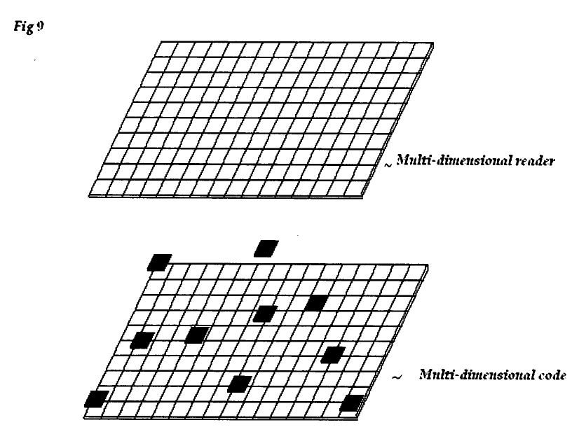

FIG. 9 shows the example diagram of 3D hologram codes and code reader. It could have optional light emitter. It reads the light from hologram light field, which is designed as coded. An example of 3D hologram code could be 3D hologram/holography QR code. Hologram is difficult to copy so it is better for security.

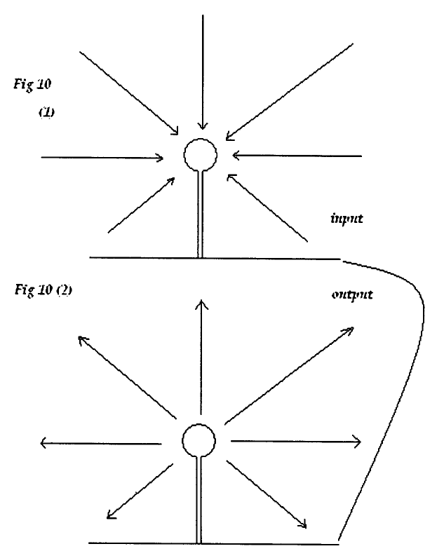

FIG. 10 (1) shows the spherical input device. This can view 360 degrees from all angles of 3D images.

FIG. 10 (2) shows the spherical output device. This could display 360 degrees from all angles of 3D images.

I claim:

1. The system that captures color multi-dimensional images having light field in the space in real time is composed of group comprising light field capturing means.

2. The system of claim [1] wherein said light field capturing means is composed of group comprising
patterns making means,
light receiving means.

3. The device of claim [2] wherein said pattern making means is composed of group comprising
liquid crystal pattern generators, polar panels, tft, controls

4. The device of claim [2] wherein said light receiving means is composed of group comprising
photo-sensors.

5. The system that input multi-dimensional fields and that output the multi-dimensional fields in the space in real time is composed of group comprising
multi-dimensional information input means,
multi-dimensional information output means,
multi-dimensional information transferring means,
multi-dimensional field controlling means,
Optional, multidimensional information analyzers
Optionally, multi-dimensional information recorders

6. The device of claim [5] wherein said multi-dimensional information input means is composed of group comprising
input device, multi-dimensional input device, three dimensional input device, three dimensional digitizer, three dimensional scanner, micro-array lens, liquid crystal pattern generators, polar panels, tft, controls, photo sensor, sound sensor, particle sensor, super-string sensor

7. The device of claim [5] wherein said multi-dimensional information output means is composed of group comprising
output device, multi-dimensional output device, three dimensional display, multi-dimensional sound speaker, sound panels, sound units, particle emitter, super-string emitter

8. The device of claim [5] wherein said multi-dimensional information transfer means is composed of group comprising
wire, wireless, internet, computer, integrated circuit, information transfer, wave signal transfer, wave signal modulator

9. The device of claim [5] wherein said multi-dimensional information controlling means is composed of group comprising
computers, integrated circuit, tft, battery, wires, antenna, wireless, wave signal controller

12. The cloaking device, that hides objects as if there are no objects, is composed of group comprising
field receiving units,
field emitting units,
optional bulletproof materials,
optional temperature controls,
optional batteries,
optional solar energy sheets,
optional controllers

13. The multi-dimensional camera and video device of claim [5] wherein said system is composed of group comprising
three dimensional input device, sensors, three dimensional output device, displays, data recording device, data transferring device, controlling units, computers, integrated circuits

14. The communication device of claim [5] wherein said device is composed of group comprising
input device, output device, 3D input cameras, 3D display, light source, liquid crystal display, liquid crystal masks, organic eluminescent display, eluminescent display, e-ink, liquid crystal pattern generators, polar panels, tft, controls, etc

15. The multi-dimensional television device of claim [5] wherein said device is composed of group comprising
input device, output device, 3D input cameras, 3D display, light source, transferring device, optional recording device, optional digital video device.

16. The multi-dimensional camera and video device of cell-phone of claim [5] wherein said system is composed of group comprising
three dimensional input device, three dimensional camera, sensors, three dimensional output device, displays, data recording device, data transferring device, controlling units, computers, integrated circuits, input buttons, speakers, microphone

17. The multi-dimensional code reader of claim [1] wherein said system is composed of group comprising
input device, multi-dimensional input device, hologram reading device, hologram codes, three dimensional hologram codes, three dimensional holography codes, holographic qr codes, optional recording device, optional light emitter, optional expression device

18. The multi-layers device of claim [1] wherein said system is composed of group comprising
multi-layers sensing device of fields

19. The spherical shape device of claim [1] wherein said system is composed of group comprising
dynamic mask patterns, input device, liquid crystals, sensors

20. The flat shape device of claim [1] wherein said system is composed of group comprising
dynamic mask patterns, input device, liquid crystals, sensors
